(19) United States
(12) Patent Application Publication
(10) Pub. No.: US 2016/0266269 A1
(43) Pub. Date: Sep. 15, 2016

(54) Time-Lapse Electromagnetic Monitoring

(71) Applicant: HALLIBURTON ENERGY SERVICES, INC., Houston, TX (US)

(72) Inventors: Glenn A. WILSON, Houston, TX (US); Burkay DONDERICI, Houston, TX (US); Ahmed FOUDA, Houston, TX (US)

(21) Appl. No.: 14/760,718

(22) PCT Filed: Apr. 16, 2014
(86) PCT No.: PCT/US2014/034416

§ 371 Date: Jul. 14, 2015

(51) Int. Cl. G01V 3/26; G01V 99/00; E21B 49/00

(52) U.S. Cl. CPC G01V 3/26; E21B 49/00; G01V 99/005; E21B 47/18

(57) ABSTRACT

A time-lapse electromagnetic (EM) monitoring system for a formation includes at least one EM source and at least one EM field sensor to collect EM survey data corresponding to the formation in response to an emission from the at least one EM source. The EM survey data includes first EM data collected at a first time and second EM data collected at a second time. The time-lapse EM monitoring system also includes a processing unit in communication with the at least one EM field sensor. The processing unit determines time-lapse EM data based on the first EM data and the second EM data, and performs an analysis of the time-lapse EM data to determine an attribute change in an earth model.

### BACKGROUND

During oil and gas exploration and production, many types of information are collected and analyzed. The information is used to determine the quantity and quality of hydrocarbons in a reservoir, and to develop or modify strategies for hydrocarbon production. One technique for collecting relevant information involves monitoring electromagnetic (EM) fields. Previous EM monitoring techniques do not appear to have adequately addressed techniques for time-lapse EM analysis, where EM survey data collected at two different times is analyzed to determine changes to a downhole environment. Efforts to improve and to efficiently obtain meaningful information from time-lapse EM analysis are ongoing.

### BRIEF DESCRIPTION OF THE DRAWINGS

Accordingly, there are disclosed herein various time-lapse electromagnetic (EM) monitoring methods and systems, in which time-lapse EM data is directly inverted to determine an attribute change in an earth model. In the drawings:

FIGS. 1A-1C show illustrative time-lapse EM analysis scenarios.

FIG. 2 shows an illustrative logging-while-drilling (LWD) environment in which EM survey data may be collected.

FIG. 3 shows an illustrative wireline logging environment in which EM survey data may be collected.

FIG. 4 shows an illustrative monitoring well environment in which EM survey data may be collected.

FIGS. 5A and 5B show illustrative EM field sensor telemetry configurations.

FIG. 6 shows an illustrative time-lapse EM analysis method.

FIG. 7 shows a block diagram of an illustrative workflow with time-lapse EM analysis operations.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

The following disclosure is directed to time-lapse electromagnetic (EM) monitoring and analysis technology. The disclosed techniques employ at least one EM field sensor to collect EM survey data corresponding to a formation of interest, where the EM survey data includes first EM data collected at a first time and second EM data collected at a second time. A processing unit in communication with the at least one EM field sensor determines observed time-lapse EM data based on the first EM data and the second EM data. The processing unit performs an analysis of the observed time-lapse EM data to determine an attribute change in an earth model. In at least some embodiments, the determined attribute change corresponds to or is related to a change in resistivity. This attribute change may be used to update a resistivity model, a water saturation model, or other models related to an earth model. In some embodiments, the analysis of the observed time-lapse EM data is a direct inversion of time-lapse EM data, rather than separate inversions of EM data collected at different times.

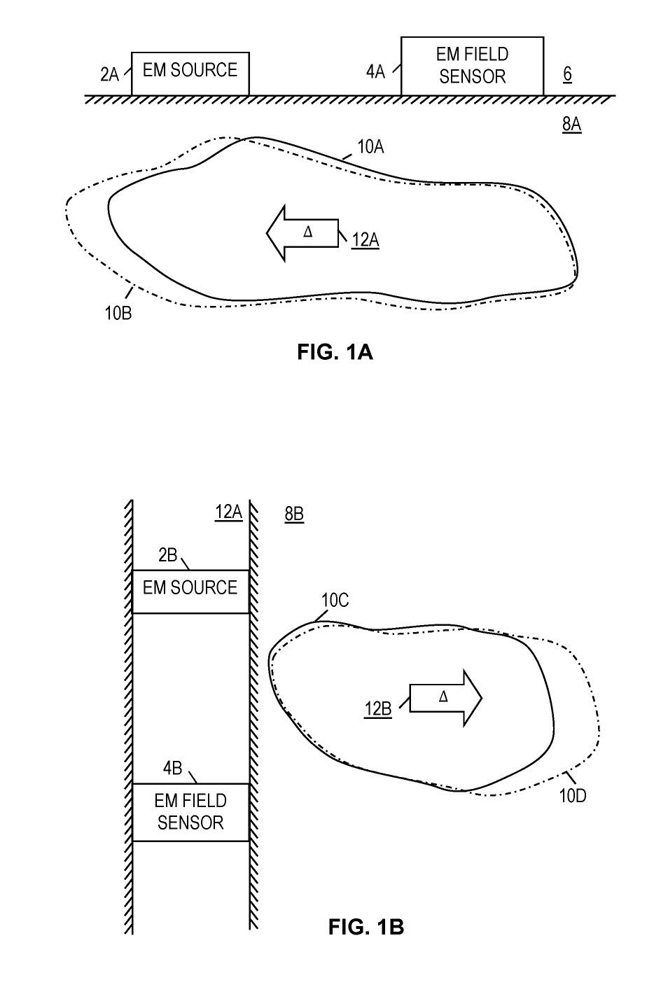

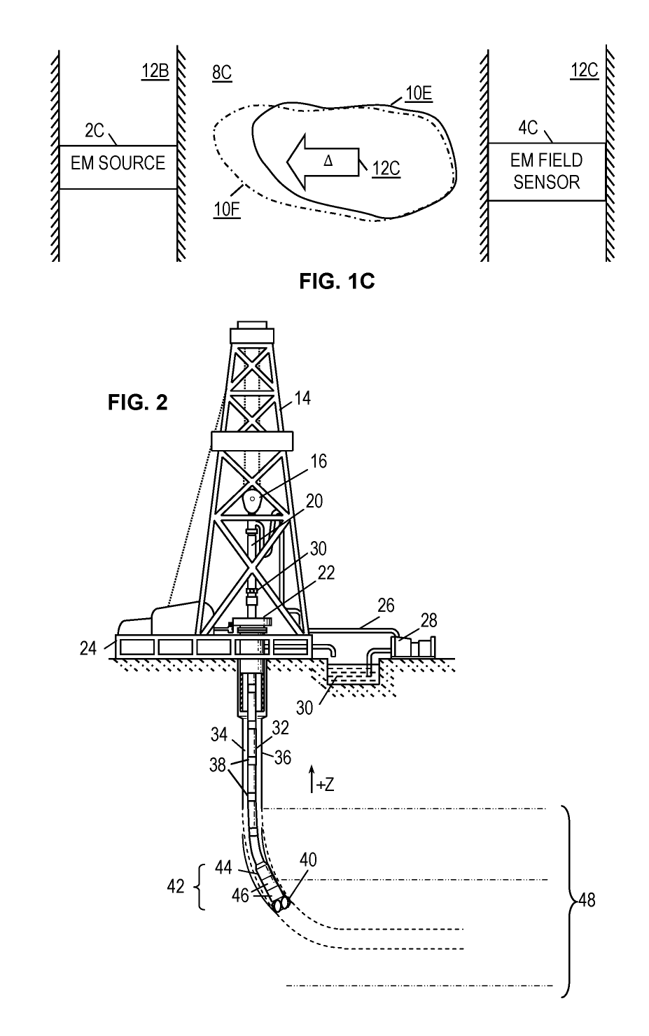

FIGS. 1A-1C show illustrative time-lapse EM analysis scenarios. FIG. 1A shows an EM source 2A and an EM field sensor 4A at earth's surface 6 to conduct EM surveys for formation 8A. To conduct an EM survey, the EM source 2A emits an EM field, and the EM field sensor 4A detects an EM signal in response to the emitted EM field. At time T1, the detected EM signal is affected by properties of the formation 8A including formation region or volume 10A. The survey is repeated at time T1+delay, when the detected EM signal is affected by properties of the formation 8A including formation region or volume 10B. Assuming that the position of the EM source 2A and the EM field sensor 4A do not change, at least the movement of fluids in the formation 8A may cause the EM survey data corresponding to time T1 and time T1+delay to be different. The EM survey data may also change by varying the control parameters or position of the EM source 2A and/or the EM field sensor 4A. As long as relevant EM survey parameters (e.g., control parameters, position, etc.) are tracked, an estimate of changes in the EM survey data that are due to movement of fluids (or other formation attribute changes) can be obtained from time-lapse EM analysis of the EM survey data collected at time n and time n+delay. Such formation attribute changes are represented by Δ arrow 12A. As described herein, the delay value may vary, though it is expected to be in the range where measurable fluid front movement has occurred (i.e., more than 1 day and typically on the order of hundreds of days). A more detailed explanation of time-lapse EM analysis techniques is provided hereafter.

In the scenario of FIG. 1B, EM source 2B and EM field sensor 4B reside in a borehole 12A to conduct EM surveys for formation 8B. For example, the EM source 2B and the EM field sensor 4B may be part of a LWD tool, a wireline logging tool, or permanent well installations (e.g., injection wells, production wells, or monitoring wells). As the arrangement of the EM source 2B and the EM field sensor 4B is different compared to the arrangement of EM source 2A and the EM field sensor 4A described in FIG. 1A (the EM source 2B and EM field sensor 4B are downhole rather than at the surface), the survey measurements may be more sensitive to changes 12B in near-wellbore formation regions 10C and 10D. As with FIG. 1A, EM survey data is collected by EM field sensor 4B in response to EM fields emitted by EM source 2B at time T1 and time T1+delay. The positioning of an EM source and EM field sensors relative to each other and to a formation determines which formation region most strongly affects the collected EM survey data and the related time-lapse EM data. As desired, additional EM sources and/or EM field sensors may be employed in scenarios of FIGS. 1A-1B to expand the survey region. Further, the resolution of EM survey data can be adjusted by increasing or decreasing the number of EM sources and/or EM field sensors employed. Further, the spacing between EM sources and/or EM field sensors may vary.

In the scenario of FIG. 1C, EM source 2C and EM field sensor 4C reside in different boreholes 12B and 12C to conduct EM surveys for formation 8C. For example, the EM source 2C and the EM field sensor 4C may each individually be part of a LWD tool, a wireline logging tool, or permanent well installations. Due to the arrangement of the EM source 2C and the EM field sensor 4C being different compared to the arrangement of EM sources and sensors in scenarios of FIGS. 1A-1B (a cross-well arrangement is shown rather than a surface arrangement or single borehole arrangement), the survey measurements may be more sensitive to changes 12C in formation regions 10E and 10F. As with FIGS. 1A-1B, EM survey data is collected by EM field sensor 4C in response to EM fields emitted by EM source 2C at time T1 and time T1+delay.

The scenarios of FIGS. 1A-1C are not intended to limit embodiments to a particular arrangement of EM sources and/or EM field sensors. For example, the scenarios of FIGS. 1A-1C could be combined such that EM sources and/or EM field sensors are located at the earth's surface, at the seafloor, in a single borehole, and/or in multiple boreholes. Further, EM survey data may additionally or alternatively be collected using ambient EM phenomena in the downhole environment (a controlled EM source is not needed).

The EM sources and/or EM field sensor(s) used to collect EM survey data may be temporarily or permanently positioned in a downhole environment. Temporary positioning EM sources and/or EM field sensors in a downhole environment may involve, for example, logging-while-drilling (LWD) operations or wireline logging operations with one or more EM sources and/or EM field sensors. Meanwhile, permanent positioning of EM sources and/or EM field sensors in a downhole environment may involve, for example, permanent well installations with one or more EM sources and/or EM field sensors.

While collecting EM survey data using the same EM source and EM field sensor positions facilitates time-lapse EM analysis, it should be noted that EM survey data collected at different times may include EM data where the EM source position and/or the EM field sensor position has changed. In such case, collected position information for the EM source and/or the EM field sensors can be used to determine time-lapse EM data as described herein.

The collection of EM survey data and the disclosed time-lapse EM analysis techniques can be best appreciated in suitable application contexts such as an LWD environment, a wireline logging environment, and/or permanent well installations.

FIG. 2 shows an illustrative drilling environment having a drilling platform 24 that supports a derrick 14 having a traveling block 16 for raising and lowering a drill string 32. A drill string kelly 20 supports the rest of the drill string 32 as it is lowered through a rotary table 22. The rotary table 22 rotates the drill string 32, thereby turning a drill bit 40. As bit 40 rotates, it creates a borehole 36 that passes through various formations 48. A pump 28 circulates drilling fluid through a feed pipe 26 to kelly 20, downhole through the interior of drill string 32, through orifices in drill bit 40, back to the surface via the annulus 34 around drill string 32, and into a retention pit 30. The drilling fluid transports cuttings from the borehole 36 into the pit 30 and aids in maintaining the integrity of the borehole 36. Various materials can be used for drilling fluid, including oil-based fluids and water-based fluids.

As shown, logging tools 46 may be integrated into the bottom-hole assembly 42 near the drill bit 40. As the drill bit 40 extends the borehole 36 through the formations 48, logging tools 46 may collect measurements relating to various formation properties as well as the tool orientation and various other drilling conditions. Each of the logging tools 46 may take the form of a drill collar, i.e., a thick-walled tubular that provides weight and rigidity to aid the drilling process. For the present discussion, the logging tools 46 are expected to include EM field sensors and/or EM sources. The logging tools 46 may also include position sensors to collect position information related to EM survey data. In alternative embodiments, EM sources, EM field sensors, and/or position sensors may be distributed along the drill string 32. For example, EM sources, EM field sensors, and/or position sensor may be attached to or integrated with adapters 38 that join sections of the drill string 32 together. In such case, electrical wires and/or optical fibers may extend through an interior of the drill string 32, through sections of the drill string 32, and/or in/through the adaptors 38 to enable collection of EM survey data and/or position data.

In some embodiments, measurements from the EM field sensors and/or position sensors are transferred to the surface using known telemetry technologies or communication links. Such telemetry technologies and communication links may be integrated with logging tools 46 and/or other sections of drill string 32. As an example, mud pulse telemetry is one common technique for providing a communications link for transferring logging measurements to a surface receiver 30 and for receiving commands from the surface, but other telemetry techniques can also be used. In some embodiments, the bottom-hole assembly 42 includes a telemetry sub 44 to transfer measurement data to the surface receiver 30 and to receive commands from the surface. In alternative embodiments, the telemetry sub 44 does not communicate with the surface, but rather stores logging data for later retrieval at the surface when the logging assembly is recovered.

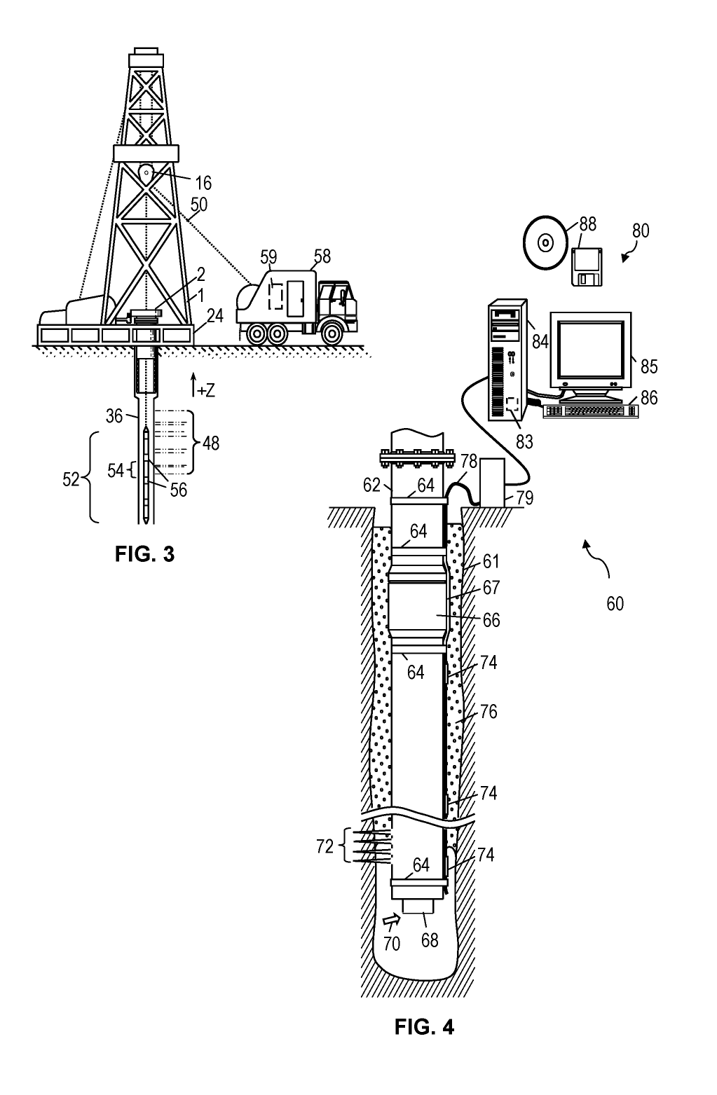

At various times during the drilling process, or after the drilling has been completed, the drill string 32 shown in FIG. 2 may be removed from the borehole 36. Once the drill string 32 has been removed, as shown in FIG. 3, a wireline tool string 52 can be lowered into the borehole 36 by a cable 50. In some embodiments, the cable 50 includes conductors and/or optical fibers for transporting power to the wireline tool string 52 and data/communications from the wireline tool string 52 to the surface. It should be noted that various types of formation property sensors can be included with the wireline tool string 52. In accordance with the disclosed time-lapse EM analysis techniques, the illustrative wireline tool string 52 includes logging sonde 54 with EM sources, EM field sensors, and/or position sensors. The logging sonde 54 may be attached to other tools of the wireline tool string 52 by adaptors 56.

In FIG. 3, a wireline logging facility 58 receives measurements from the EM field sensors, position sensors, and/or or other instruments of the wireline tool string 52 collected as the wireline tool string 52 passes through formations 48. In some embodiments, the wireline logging facility 58 includes computing facilities 59 for managing logging operations, for acquiring and storing measurements gathered by the logging sonde 54, for inverting measurements to determine formation properties, and/or for displaying measurements or formation properties to an operator. In some embodiments, the wireline tool string 52 may be lowered into an open section of the borehole 36 or a cased section of the borehole 36. In a cased borehole environment, the casing may cause attenuation to signals that are received by the EM field sensors. However, the EM survey data can still be collected in a cased borehole environment, especially at low frequencies where attenuation due to casing is low.

FIG. 4 shows an illustrative monitoring well environment. In FIG. 4, well 60 includes borehole 61 containing a casing string 62 with a cable 78 secured to it by bands 64. The casing string 62 includes multiple tubular casing sections (usually about 30 foot long) connected end-to-end by couplings. The cable 78 enables data and/or power transmissions and may correspond to an electrical conductor or optical fibers. Where the cable 78 passes over a casing joint 66, it may be protected from damage by a cable protector 67. The remaining annular space in the borehole 61 may be filled with cement 76 to secure the casing string 62 in place and to prevent fluid flows in the annular space.

The well 60 is adapted to guide fluids 70 (e.g., oil or gas) from the bottom of the borehole 61 to earth's surface or vice versa. For example, fluids 70 can enter the borehole 61 through uncemented portions or via perforations 72. Such perforations 72 near the bottom of the borehole 61 may extend through cement 76 and casing string 62 to facilitate the flow of fluid 70 from a surrounding formation (i.e., a “formation fluid”) into the borehole 61 and thence to the surface via an opening at the bottom of or along production tubing string 68. Though only one perforated zone is shown for well 60, many wells may have multiple such zones, which enable production from different formations. Each such formation may produce oil, gas, water, or combinations thereof at different times. Alternatively, the well 60 may inject fluid into the borehole 61 and the different formations.

In FIG. 4, EM field sensors 74 couple to the cable 78 to enable collection of EM survey data that is conveyed to a surface interface 79 via the cable 78. In some embodiments, cable 78 may correspond to wired casing or wired production tubing with couplers that provide continuity of integrated electrical or optical paths. In such embodiments, some or all of the couplers may further include integrated EM field sensors 74. Alternatively, cable 78 could be arranged inside or outside of normal, metallic coiled tubing. Alternatively, cable 78 could be arranged on the inside of or attached to the outside of the production tubing string 68. In at least some embodiments, the EM field sensors 74 use wireless communications to convey EM field measurements to the surface or to a downhole interface that conveys the measurement received from the EM field sensors 74 to the surface. The EM field sensors 74 may in some cases implement a mesh network to transfer data in a bucket-brigade fashion to the surface.

The surface interface 79 may be coupled to a computer 80 that acts as a data acquisition system and/or a data processing system that analyzes the EM field measurements to perform time-lapse EM analysis as described herein and/or other types of data analysis. As an example, the computer 80 (e.g., using processor 83) may process EM survey data, including first EM data collected at a first time and second EM data collected at a second time, to determine time-lapse EM data. The computer 80 also may perform an inversion of the time-lapse EM data to determine an attribute change in an earth model. Further, the computer 80 or another control system may direct control options for EM sources (e.g., EM sources 2A, 2B, 2C). Such control options may include waveform options, current level options, and timing synchronization between EM sources (e.g., EM sources 2A, 2B, 2C) and EM field sensors (e.g., EM field sensors 4A, 4B, 4C).

As shown, the computer 80 includes a chassis 84 that houses various electrical components such as processor 83, memories, drives, graphics cards, etc. The computer 80 also includes a monitor 85 that enables a user to interact with the software via a keyboard 86 or other input devices. Examples of input devices that may be used with or instead of keyboard 86 include a mouse, pointer devices, and touchscreens. Further, other examples of output devices that may be used with or instead of monitor 85 include a printer. Software executed by the computer 80 can reside in computer memory and on non-transitory information storage media 88. The computer may be implemented in different forms including, for example, an embedded computer installed as part of the surface interface 79, a portable computer that is plugged into the surface interface 79 as desired to collect data, a remote desktop computer coupled to the surface interface 79 via a wireless link and/or a wired computer network, a mobile phone/PDA, or indeed any electronic device having a programmable processor and an interface for I/O.

In different embodiments, the time-lapse EM analysis operations described herein may be performed by serial and/or parallel processing architectures. In some embodiments, the processing operations for time-lapse EM analysis may be performed remotely from the reservoir (e.g., cloud computers). For example, computers or communication interfaces at the reservoir site may be connected to remote processing computers via a network. Accordingly, computers at the reservoir site do not necessarily need high computational performance. Subject to network reliability, the time-lapse EM analysis operations described herein may be performed in real-time to update production, enhanced oil recovery (EOR) operations, and/or other operations.

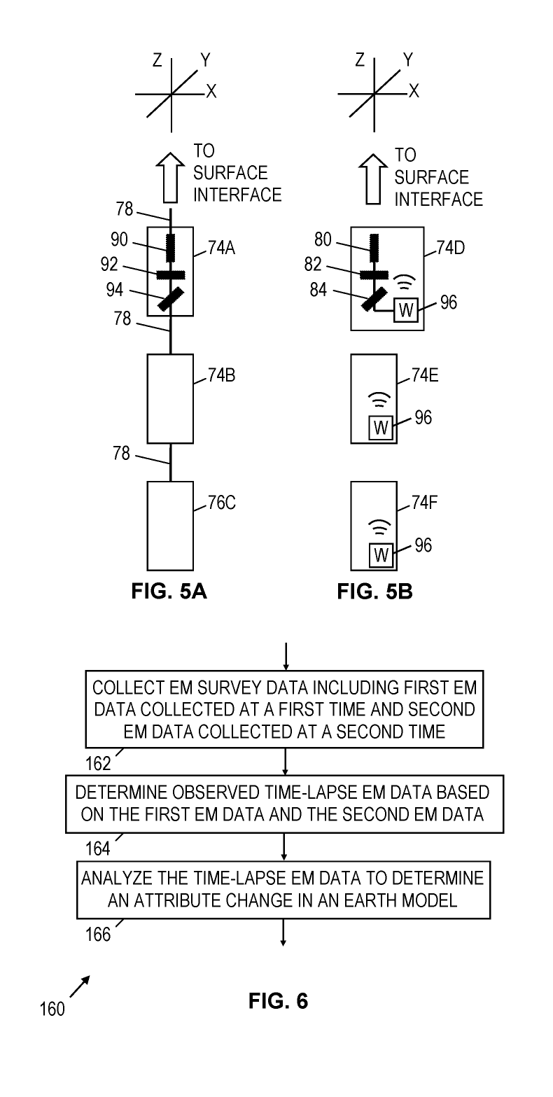

FIGS. 5A and 5B show illustrative EM field sensor telemetry configurations that could be implemented in the environments of FIGS. 2-4. In FIG. 5A, sensor groups 74A-74C couple to cable 78 to perform EM field measurements and/or to convey EM field measurements to a surface interface (e.g., interface 79). Each of the sensor groups 74A-74C may include orthogonal EM field sensors 90, 92, 94 (not shown for groups 74B and 74C), where sensor 90 is oriented along the z-axis, sensor 92 is oriented along the x-axis, and sensor 94 is oriented along the y-axis. In some embodiments, the cable 78 corresponds to one or more electrical conductors to carry data and/or power. In such case, the EM field sensors 90, 92, 94 may correspond to coils, electrodes, or another type of transducer that generates or modifies an electrical signal in response to an ambient EM field. The generated or modified electrical signal is transmitted to a surface interface (e.g., interface 79) via cable 78, where its characteristics can be interpreted to decode information about the EM field sensed by one or more of the sensors 90, 92, 94 in sensor groups 74A-74C.

In another embodiment, the cable 78 corresponds to one or more optical fibers to carry data and/or power. In such case, the EM field sensors 90, 92, 94 generate or modify a light signal in response to sensing an ambient EM field. The generated or modified light signal is transmitted to a surface interface (e.g., interface 79) via one or more optical fibers. The surface interface converts the light signal to an electrical signal, whose characteristics encode information about the EM field sensed by sensor groups 74A-74C. It should also be understood that electro-optical converters may also be employed to change electrical signals to optical signals or vice versa. Thus, EM field sensors that generate or modify a light signal could be part of a system where cable 78 has electrical conductors. In such case, the generated or modified light signal is converted to an electrical signal for transmission via cable 78. Similarly, EM field sensors that generate or modify an electrical signal could be part of a system where cable 78 has optical fibers. In such case, the generated or modified electrical signal is converted to a light signal for transmission via cable 78.

In FIG. 5B, each of the sensor groups 74D-74F includes orthogonal EM field sensors 90, 92, 94 (not shown for groups 74E and 74F), oriented as described for FIG. 5A. Further, each of the sensor groups 74D-74F includes a wireless interface 96 to enable communications with a surface interface (e.g., interface 79). Each wireless interface 96 may include a battery, at least one wireless module, and a controller. In at least some embodiments, the wireless interfaces 96 are part of a wireless mesh in which short-range wireless communications are used to pass data from one wireless interface 96 to another until the data is received by a surface interface. As an example, a short-range wireless protocol that could be employed by each wireless interface 96 is Bluetooth®. EM field sensor configurations such as those shown in FIGS. 5A and 5B may vary with respect to the position of sensor groups, the types of sensors used, the orientation of sensors, the number of cables/fibers used, the wireless protocols used, and/or other features.

FIG. 6 shows an illustrative time-lapse EM analysis method 160. The method 160 may be performed, for example, by one or more computers (e.g., computer 59 of FIG. 3, or computer 80 of FIG. 4) in communication with EM sources (e.g., EM sources 2A, 2B, 2C) and/or EM field sensors (e.g., EM field sensors 4A, 4B, 4C). As shown, the method 160 comprises collecting EM survey data including first EM data collected at a first time and second EM data collected at a second time (block 162). At block 164, observed time-lapse EM data is determined based on the first EM data and the second EM data. In at least some embodiments, the observed time-lapse EM data may be determined by defining a relationship between the first EM data and the second EM data. For example, the relationship may be a perturbation tensor or scalar value that defines a relationship between the first EM data and the second EM data. Further, the method 160 may include changing the relationship as a function of delay between the first and second times. For shorter delays (e.g., less than a couple of days), a scalar value may be used as the relationship metric. See e.g., equation (17). For medium delays (e.g., 2-7 days), a reduced perturbation tensor may be used as the relationship metric. See e.g., equation (16). For longer delays (e.g., more than 7 days), a perturbation tensor may be used as the relationship metric. See e.g., equation (15).

At block 166, the observed time-lapse EM data is analyzed to determine an attribute change in an earth model. In at least some embodiments, the analysis step of block 166 may include comparing the observed time-lapse EM data with simulated time-lapse EM data. Further, the analysis step of block 166 may include relating the time-lapse EM data to a change in resistivity. Without limitation, the analysis step of block 166 may subject attribute changes of an earth model to one or more rock physics constraints and/or to history-matched constraints. Further, the analysis step of block 166 may apply a sensitivity-based analysis to determine the attribute change.

In at least some embodiments, the method 160 may include additional steps. For example, the method 160 may additionally include determining position data corresponding to one or both of the first EM data and the second EM data, and using the position data to determine the observed time-lapse EM data. In this manner, differences in position for EM sources and/or EM field sensors may be accounted for.

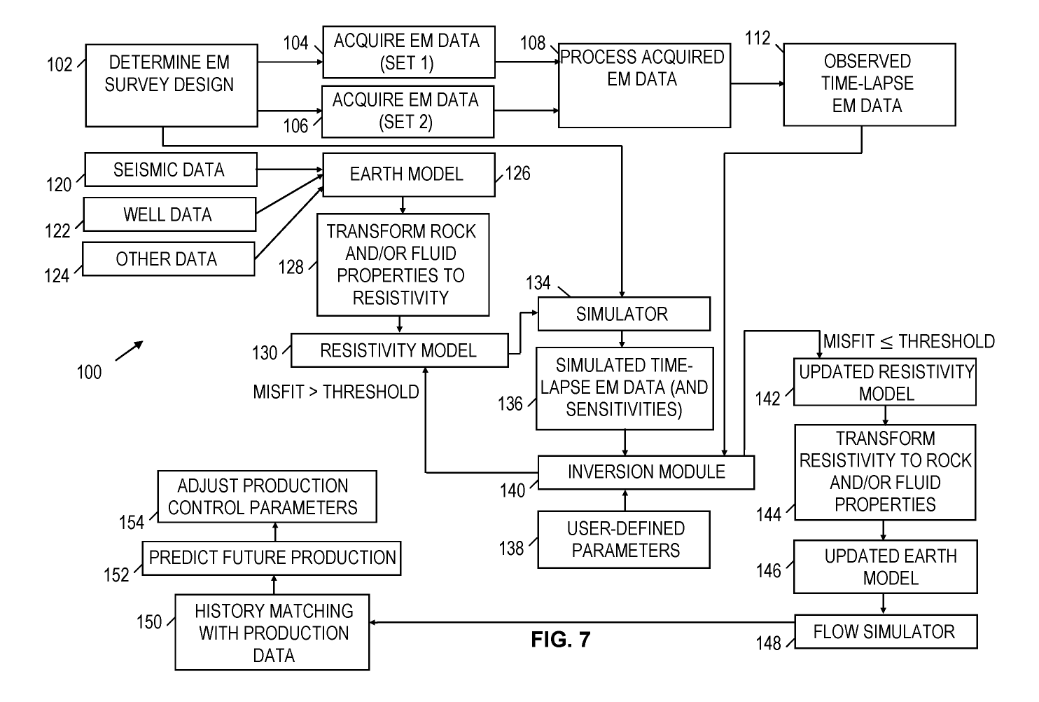

FIG. 7 shows an illustrative workflow 100 suitable for use with time-lapse EM analysis operations. In workflow 100, the EM survey design is determined at block 102. For example, the EM survey design may include position, spacing, and control parameters for EM source and EM field sensors. At block 104, a first set of EM data is collected. At a later time, a second set of EM data is collected at block 106. The first and second sets of EM data are processed at block 108 to obtain time-lapse EM data 112. As will be discussed in greater detail below, the time-lapse EM data 112 may correspond to perturbed electric field values. The time-lapse EM data 112 is provided to inversion block 140.

The inversion block 140 also receives simulated time-lapse EM data 136 and user-defined parameters 138 as input. Examples of parameters 138 may include adaptation step sizes, constraints on model values, and criteria for terminating the inversion process. The simulated time-lapse EM data 136 is determined by a simulator 134 that receives the EM survey design 102 and a resistivity model 130 as input. In at least some embodiments, the simulator 134 also may provide sensitivity information to the inversion block 140. The resistivity model 130 is initially derived from a transformation of an earth model 126, which in turn is obtained using seismic data 120, well data 122, and/or other data 124. The transformation block 128 determines an initial resistivity model 130 based on rock and/or fluid properties of the earth model 126.

In at least some embodiments, the inversion block 140 compares the simulated time-lapse EM data 136 with the measured time-lapse EM data 112. If the misfit (error) between the simulated time-lapse EM data 136 and the time-lapse EM data 112 is greater than a threshold, the resistivity model 130 is updated, the EM measurement simulation is repeated at block 134, and the simulated time-lapse EM data is re-determined. An iterative process of comparing simulated time-lapse EM data 136 with the time-lapse EM data 112, updating the resistivity model 130, and re-simulating continues until the misfit between the simulated time-lapse EM data 136 and the time-lapse EM data 112 is less than or equal to the threshold. The result of this iterative process is an updated resistivity model 142 that conforms to the time-lapse EM data 112 to within a threshold tolerance.

At block 144, resistivity values of the updated resistivity model 142 are transformed to rock and/or fluid properties to obtain an updated earth model 146. The updated earth model 146 is used, for example, by a flow simulator 148 to predict future production 152. In at least some embodiments, the output of the flow simulator 148 is compared with production data by history matching block 150 to predict future production 152. Production control parameters are adjusted accordingly at block 154 to update production.

Thus workflow 100 represents an improved method of time-lapse EM analysis and shows how it may be used to update production control parameters. A more detailed discussion incorporating specific time-lapse EM analysis modeling concepts is now provided.

Generally, the electrical properties of a formation are heterogeneous and the distribution of the electrical properties in an earth model of the formation can be assumed to be piecewise continuous. For example, a three-dimensional (3D) earth model volume can be constructed as the juxtaposition of volume elements populated by discrete values of the electrical properties and the EM fields and/or sensitivities modeled using a 3D numerical simulator. For the purpose of 3D EM modeling, the 3D conductivity model can be separated into background (b) and anomalous (a) parts (having a spatial dependence represented by the coordinate vector r):

\hat{σ}(r)=\hat{σ}_{b}(r)+\hat{σ}ₐ(r), (1)

which can be complex, frequency-dependent, and be described by a second rank tensor:

$$\hat{σ} = [ \begin{matrix}{σ}_{xx} & {σ}_{xy} & {σ}_{xz} \\ {σ}_{yx} & {σ}_{yy} & {σ}_{yz} \\ {σ}_{zx} & {σ}_{zy} & {σ}_{zz}\end{matrix} ] , \qquad ( 2 )$$

which, due to energy considerations, is symmetric. It follows that Maxwell's equations can separate the electric and magnetic fields into background (b) and anomalous (a) parts:

E(r)=E_{b}(r)+Eₐ(r), (3)

H(r)=H_{b}(r)+Hₐ(r), (4)

where the background fields are computed for the extraneous sources and the background conductivity model, and the anomalous fields are computed for scattering currents in the anomalous conductivity model. In EM modeling, the background conductivity model may be chosen such that the background fields can be evaluated analytically (e.g., homogenous average conductivity) or semi-analytically (e.g., horizontal conductivity layers) to avoid subsequent numerical instabilities in the solution of the anomalous fields.

Further, Maxwell's equations may be solved in either of their differential or integral forms. For example, the EM fields can be written as the Fredholm integral equations of the second kind:

E(r′)=E_{b}(r′)+∫_{V}Ĝ_{E}(r′,r)σₐ(r)[E_{b}(r)+Eₐ(r)]d³r, (5)

H(r′)=H_{b}(r′)+∫_{V}Ĝ_{H}(r′,r)σₐ(r)[E_{b}(r)+Eₐ(r)]d³r, (6)

where Ĝ_{E,H} is the electric or magnetic Green's tensor for the background conductivity model. In EM modeling, the background conductivity model may be chosen such that the Green's tensors can be evaluated analytically or semi-analytically to avoid subsequent numerical instabilities in the solution of the anomalous fields. See e.g., A Raiche, A flow-through Hankel transform technique for rapid, accurate Green's function computation: Radio Science, 34 (2) 549-555 (2000). However, in some embodiments, the Green's tensors may be evaluated numerically for inhomogeneous background conductivity models.

While equations (5) and (6) are nonlinear, initially requiring the solution of equation (5) within the 3D earth model, equations (5) and (6) can be linearized by assuming there exists a linear relation between the anomalous and background electric fields within the 3D earth model:

Eₐ(r)=\hat{k}(r)E_{b}(r), (7)

where \hat{k}(r′) is a second rank tensor:

$$\hat{k} = [ \begin{matrix}{k}_{xx} & {k}_{xy} & {k}_{xz} \\ {k}_{yx} & {k}_{yy} & {k}_{yz} \\ {k}_{zx} & {k}_{zy} & {k}_{zz}\end{matrix} ] , \qquad ( 8 )$$

such that:

E(r′)=E_{b}(r′)+∫_{V}Ĝ_{E}(r′,r)σₐ(r)[1+\hat{k}(r)]E_{b}(r)d³r, (9)

H(r′)=H_{b}(r′)+∫_{V}Ĝ_{H}(r′,r)σₐ(r)[1+\hat{k}(r)]E_{b}(r)d³r. (10)

The form of the tensor relating the anomalous and background electric fields can be quite arbitrary. Published literature shows that a prejudicial choice of the form of the tensor 1c can reduce equations (9) and (10) to a variety of approximations, such as the Born approximation, extended Born approximation, localized nonlinear approximation, quasi-linear approximation, localized quasi-linear approximation, and quasi-linear approximation. See e.g., T. M. Habashy, R. W. Groom, and B. R. Spies, Beyond the Born and Rytov approximations: A nonlinear approach to electromagnetic scattering: Journal of Geophysical Research, 98 (B2), 1759-1775 (1993), and M. S. Zhdanov, Geophysical inverse problems and regularization theory: Elsevier, Amsterdam (2002). These various approximations can decrease computational complexity. However, these various approximations are only valid for relatively low conductivity contrasts.

### Time-Lapse EM Modeling

For EM surveys with identical EM source and EM field sensor locations conducted at two different times (e.g., pre-production, during production, or combinations thereof), denoted by superscripts 1 and 2, equation (5) can be written as:

E¹(r′)=E_{b}(r′)+∫_{V}Ĝ_{E}(r′,r)σₐ¹(r)[E_{b}(r)+Eₐ¹(r)]d³r, (11)

E²(r′)=E_{b}(r′)+∫_{V}Ĝ_{E}(r′,r)σₐ²(r)[E_{b}(r)+Eₐ²(r)]d³r, (12)

Note that the background fields are constant between the two surveys, and the time-lapse change in conductivity manifests only in the change of the anomalous conductivity from σₐ¹(r) to σₐ²(r).

The time-lapse EM response is hereby defined as the difference between equations (11) and (12):

E¹(r′)−E²(r′)=∫_{E}Ĝ_{E}(r′,r){σₐ¹(r)[E_{b}(r)+Eₐ¹(r)]−σₐ²(r)[E_{b}(r)+Eₐ²(r)]}d³r. (13)

Time lapse EM data are measured as the difference between EM data from the two EM surveys conducted at different moments in time for the same EM source and EM field sensor locations. While it has been noted that survey repeatability is optimally obtained from permanent EM source and EM field sensor installations rather than from repeated temporal surveys as has been the focus of feasibility studies to date (see e.g., A. Chuprin, D. Andreis, and L. MacGregor, Quantifying factor affecting repeatability in CSEM surveying for reservoir appraisal and monitoring: SEG annual meeting, Expanded Abstracts (2008)), embodiments are not limited to permanent EM source and EM field sensor installations as the effects of differing transducer placements can often be determined and accounted for.

The difficulty with equation (13) is that it is nonlinear with respect to both the anomalous conductivity and electric fields inside the 3D earth model at both time periods. Given this nonlinearity, it is the current belief that the time lapse EM inverse problem must be solved as two separate 3D EM inversion problems corresponding to the two independent EM surveys. See e.g., N. Black, G. A. Wilson, A. V. Gribenko, M. S. Zhdanov, and E. Morris, 3D inversion of time-lapse CSEM data based on dynamic reservoir simulation of the Harding field, North Sea: SEG Annual Meeting, Expanded Abstracts (2011), and L. Srnka, J. J. Carazzone, and D. A. Pavlov, Time lapse analysis with electromagnetic data: U.S. Pat. No. 8,437,961. However, the present disclosure adopts a different approach.

While the following discussion is applied to electric fields, it should be appreciated that a relationship between anomalous magnetic fields at different times also exists and may additionally or alternatively be used for time-lapse EM analysis.

In embodiments of this disclosure, it is assumed that there exists a relation between the anomalous electric fields at the two time periods:

Eₐ²(r′)=\hat{λ}(r′)Eₐ¹(r′), (14)

where \hat{λ}(r′) is called a perturbation tensor, which is a second rank tensor that can be proven to always exist:

$$\hat{λ} = [ \begin{matrix}{λ}_{xx} & {λ}_{xy} & {λ}_{xz} \\ {λ}_{yx} & {λ}_{yy} & {λ}_{yz} \\ {λ}_{zx} & {λ}_{zy} & {λ}_{zz}\end{matrix} ] . \qquad ( 15 )$$

Equation (14) is general, in that specific values, relations or functions need not be enforced upon the perturbation tensor, whose elements may be determined from a deterministic function, from a linear minimization problem, or from a nonlinear minimization problem.

In some embodiments, the perturbation tensor can be reduced to be diagonally dominant:

$$\hat{λ} = [ \begin{matrix}{λ}_{xx} & 0 & 0 \\ 0 & {λ}_{yy} & 0 \\ 0 & 0 & {λ}_{zz}\end{matrix} ] . \qquad ( 16 )$$

In some embodiments, the perturbation tensor can be reduced to be a scalar:

$$\hat{λ} = λ [ \begin{matrix}1 & 0 & 0 \\ 0 & 1 & 0 \\ 0 & 0 & 1\end{matrix} ] = λ I , \qquad ( 17 )$$

where I is the identity tensor.

The complexity of the perturbation tensor is related to the overall complexity (i.e., non-linearity) of the time-lapse EM problem. For long time-lapse EM data under certain conditions (e.g., temporal monitoring from temporal installations), complete solutions for equation (15) may be required. For medium time-lapse EM data under certain conditions (e.g., temporal monitoring from permanent installations), equation (16) may be sufficiently accurate approximation for the perturbation tensor. For short time-lapse EM data under certain conditions (e.g., continuous monitoring from permanent installations), equation (17) may be a sufficiently accurate approximation for the perturbation tensor.

Without loss of generality, it follows that equation (14) reduces equation (13) to the integral equation:

[I−\hat{λ}(r′)]Eₐ¹(r′)=∫_{V}Ĝ_{E}(r′,r){σₐ¹(r)−σₐ²(r)}{E_{b}(r)+[I−\hat{λ}(r)]Eₐ¹(r)}d³r. (18)

If:

P(r)=[I−\hat{λ}(r)]Eₐ¹(r), (19)

and

Δσₐ(r)=σₐ¹(r)−σₐ²(r), (20)

where P(r) is the electric field perturbation and Δσₐ(r) is the change in conductivity, equation (18) can be re-written as:

P(r′)=∫_{V}Ĝ_{E}(r′,r)Δσₐ(r){E_{b}(r)+P(r)}d³r, (21)

which is recognized as a Fredholm integral equation of the second kind. It is particularly worth noting that the integral in equation (21) will only have contributions from those volumes of the 3D earth model where Δσₐ(r)≠0.

It is understood that in a reservoir with a waterflood, Δσₐ(r)≠0 where oil and/or gas has been displaced by water. It is also understood that in a reservoir with a gas or CO2 injection, Δσₐ(r)≠0 where oil has been displaced by if not mixed with gas or CO2. It is also understood that in an oil reservoir, Δσₐ(r)≠0 if the reservoir pressure is not maintained at or above bubble point as gas separates from oil. Such observations may enable the inversion process to particularly focus on the relatively small regions of the model where such changes might realistically occur. In any event, expressing the electric field perturbation in terms of the change in conductivity enables the use of some effective linearization approaches.

### Example of Linearization of the Perturbation Tensor: Time-Lapse Response

The following presents one example of a linearization of equation (18) to solve for a scalar perturbation tensor (17). Different methods of linearization can be applied, and the following example is not intended to limit the scope of the disclosure.

Assuming the perturbation tensor can be reduced to a scalar per equation (17) and with equation (20), equation (18) can be re-written as:

[1−λ(r′)]Eₐ¹(r′)=∫_{V}Ĝ_{E}(r′,r)Δσₐ(r){E_{b}(r)+[1−λ(r)]Eₐ¹(r)}d³r, (22)

which can be expanded as:

[1−λ(r′)]Eₐ¹(r′)=∫_{V}Ĝ_{E}(r′,r)Δσₐ(r)E_{b}(r)d³r+∫_{V}Ĝ_{E}(r′,r)Δσₐ(r)[1−λ(r)]Eₐ(r)d³r. (23)

For EM modeling, the Green's tensor Ĝ_{E}(r′, r) exhibits a singularity when r′=r which must be avoided when computing the volume integrals in equation (23). See e.g., T. M. Habashy, R. W. Groom, and B. R. Spies, Beyond the Born and Rytov approximations: A nonlinear approach to electromagnetic scattering: Journal of Geophysical Research, 98 (B2), 1759-1775 (1993). The result is that the dominant contributions to the integrals on the right hand side of equation (23) are from the observation points r that are proximal to point r′. If λ(r) is assumed to be a slowly varying function in the volume V such that λ(r′)=λ(r), then:

[1−λ(r′)]Eₐ¹(r′)≈∫_{V}Ĝ_{E}(r′,r)Δσₐ(r)E_{b}(r)d³r+[1−λ(r′)]∫_{V}Ĝ_{E}(r′,r)Δσₐ(r)Eₐ(r)d³r. (24)

If:

E_{B}(r′)=∫_{V}Ĝ_{E}(r′,r)Δσₐ(r)E_{b}(r)d³r, (25)

E_{A}(r′)=∫_{V}Ĝ_{E}(r′,r)Δσₐ(r)Eₐ(r)d³r, (26)

where E_{B}(r′)≠0 and E_{A}(r′)≠0 provided that Δσₐ(r)≠0 for all r, equation (24) can be re-written as:

[1−λ(r′)]Eₐ¹(r′)=E_{B}(r′)+[1−λ(r′)]E_{A}(r′), (27)

and re-arranged to obtain:

[1−λ(r′)][Eₐ¹(r′)−E_{A}(r′)]=E_{B}(r′). (28)

With a scalar perturbation tensor, equation (28) can be reduced to a scalar function by calculating a dot product of both sides of equation (28). Assuming that E_{B}(r′)≠0, the result is:

$$1 - λ ( {r}^{′} ) = \frac{{E}_{B} ( {r}^{′} ) \cdot {E}_{B}^{*} ( {r}^{′} )}{[ {E}_{a}^{1} ( {r}^{′} ) - {E}_{A} ( {r}^{′} ) ] \cdot {E}_{B}^{*} ( {r}^{′} )} , \qquad ( 29 )$$

where * denotes the complex conjugate. Re-arranging equation (29) results in an expression for the scalar perturbation tensor:

$$\begin{matrix}λ ( {r}^{′} ) = 1 - \frac{{E}_{B} ( {r}^{′} ) \cdot {E}_{B}^{*} ( {r}^{′} )}{[ {E}_{a}^{1} ( {r}^{′} ) - {E}_{A} ( {r}^{′} ) ] \cdot {E}_{B}^{*} ( {r}^{′} )} \\ = \frac{[ {E}_{a}^{1} ( {r}^{′} ) - {E}_{A} ( {r}^{′} ) - {E}_{B} ( {r}^{′} ) ] \cdot {E}_{B}^{*} ( {r}^{′} )}{[ {E}_{a}^{1} ( {r}^{′} ) - {E}_{A} ( {r}^{′} ) ] \cdot {E}_{B}^{*} ( {r}^{′} )} ,\end{matrix} \qquad ( 29 )$$

assuming that [Eₐ¹(r′)]−E_{A}(r′)·E_{B}*(r′)≠0, and where Eₐ¹(r′), E_{B}(r′), and E_{A}(r′) all have known (or calculated) values. The advantage of equation (29) is that the scalar perturbation tensor can be evaluated quasi-analytically.

### Example of Linearization of the Perturbation Tensor: Time-Lapse Sensitivities

For inversion, the Fréchet derivatives (or sensitivities) of equation (18) may be calculated with respect to the time lapse change in conductivity, Δσₐ(r). The following presents one example of a linearization of equation (18) to solve for a scalar perturbation tensor (17). With equation (20), equation (18) can be re-written as:

$$\begin{matrix}\frac{\partial P ( {r}^{′} )}{\partial [ Δ {σ}_{a} ( r ) ]} = \frac{\partial }{\partial [ Δ {σ}_{a} ( r ) ]} {\int }_{V}^{ } {\hat{G}}_{E} ( {r}^{′} , r ) Δ {σ}_{a} ( r ) \{ {E}_{b} ( r ) + [ 1 - λ ( r ) ] {E}_{a}^{1} ( r ) \} {d}^{3} r , \\ With \text{:} & ( 30 ) \\ \frac{\partial {\hat{G}}_{E} ( {r}^{′} , r )}{\partial [ Δ {σ}_{a} ( r ) ]} = \frac{\partial {E}_{b} ( r )}{\partial [ Δ {σ}_{a} ( r ) ]} = \frac{\partial {E}_{a}^{1} ( r )}{\partial [ Δ {σ}_{a} ( r ) ]} = 0 , & ( 31 )\end{matrix}$$

equation (30) reduces to:

$$\frac{\partial P ( {r}^{′} )}{\partial [ Δ {σ}_{a} ( r ) ]} = {\int }_{V}^{ } {\hat{G}}_{E} ( {r}^{′} , r ) \{ {E}_{b} ( r ) + [ 1 - λ ( r ) ] {E}_{a}^{1} ( r ) \} {d}^{3} r - {\int }_{V}^{ } {\hat{G}}_{E} ( {r}^{′} , r ) Δ {σ}_{a} ( r ) \frac{\partial λ ( r )}{\partial [ Δ {σ}_{a} ( r ) ]} {E}_{a}^{1} ( r ) {d}^{3} r . \qquad ( 32 )$$

Further, Quasi-Born sensitivities can be written as:

F_{QB}¹(r′)=∫_{V}Ĝ_{E}(r′,r){E_{b}(r)+Eₐ¹(r)}d³r, (33)

and equation (32) simplifies to:

$$\frac{\partial P ( {r}^{′} )}{\partial [ Δ {σ}_{a} ( r ) ]} = {F}_{QB}^{1} ( {r}^{′} ) - {\int }_{V}^{ } {\hat{G}}_{E} ( {r}^{′} , r ) \{ λ ( r ) + Δ {σ}_{a} ( r ) \frac{\partial λ ( r )}{\partial [ Δ {σ}_{a} ( r ) ]} \} {E}_{a}^{1} ( r ) {d}^{3} r . \qquad ( 34 )$$

The advantage of an equation such as equation (34) is that the Fréchet derivatives (or sensitivities) can be evaluated with minimal computational expense since all variables in equation (34) are known from modeling (18), or can be easily evaluated from known variables

$$( e . g . , \frac{\partial λ ( r )}{\partial [ Δ {σ}_{a} ( r ) ]}$$

can be simply evaluated from the chain rule differentiation of equation (29)).

### Rock Physics Constraints on Formation Conductivity

The effective conductivity of a reservoir formation can be frequency-dependent (i.e., inclusive of dielectric and/or induced polarization effects) and either scalar or anisotropic. The effective conductivity can be expressed through an “effective medium” model and described in terms of rock and fluid properties such as porosity, permeability, fluid (oil/gas/water) saturation, and rock matrix composition. These effective medium models can be derived analytically, semi-analytically, or empirically. In waterflood monitoring, the water saturation is the most critical fluid parameter. Since the time-lapse change in conductivity can be related to the time-lapse change in water saturation via a continuous and differentiable function:

Δσₐ(r)=f[ΔS_{W}(r)], (35)

it follows that the sensitivities with respect to the time-lapse change in water saturation can be calculated as:

$$\frac{\partial }{\partial [ Δ {S}_{w} ( r ) ]} = \frac{\partial [ Δ {σ}_{a} ( r ) ]}{\partial [ Δ {S}_{w} ( r ) ]} \frac{\partial }{\partial [ Δ {σ}_{a} ( r ) ]} . \qquad ( 36 )$$

It is understood that the effective conductivity can also be inclusive of macro-scale rock and fluid properties, such as natural and/or induced fractures and/or proppants and/or other introduced fluids. For example, the effective (scalar) conductivities of reservoir formations have long been described by the empirically-derived Archie's Law:

$${σ}_{e} = \frac{1}{a} {σ}_{f} {φ}^{m} {S}_{f}^{n} , \qquad ( 37 )$$

which relates the effective (scalar) conductivity σₑ of a porous medium as a function of the tortuosity factor a, fluid conducitivity σ_{f}, porosity φ, cementation exponent m, fluid saturation S_{f}, and saturation exponent n; assuming that the rock matrix is non-conductive. Archie's law is widely accepted as being relevant for sandstone reservoirs absent of clay minerals.

Assuming a clean sandstone reservoir formation (n=1), and that the conductivity of brine is (typically) much larger than the conductivity of oil, this implies that the time-lapse change in conductivity can be expressed as:

$$\begin{matrix}Δ {σ}_{a} ( r ) = \frac{1}{a} {σ}_{w} {φ}^{m} ( r ) Δ {S}_{w} ( r ) - \frac{1}{a} {σ}_{o} {φ}^{m} ( r ) Δ {S}_{o} ( r ) \\ \approx \frac{1}{a} {σ}_{w} {φ}^{m} ( r ) Δ {S}_{w} ( r ) ,\end{matrix} \qquad ( 38 )$$

where all change in the effective conductivity can be attributed to brine displacement of oil along the oil-water contact. The conductivity of brine can be estimated from injection water analysis, and the porosity known a priori from reservoir models. From equation (38), a derivative is obtained:

$$\begin{matrix}\frac{\partial [ Δ {σ}_{a} ( r ) ]}{\partial [ Δ {S}_{w} ( r ) ]} = \frac{1}{a} {σ}_{w} {φ}^{m} ( r ) , \\ such that & ( 39 ) \\ \frac{\partial }{\partial [ Δ {S}_{w} ( r ) ]} = \frac{1}{a} {σ}_{w} {φ}^{m} ( r ) \frac{\partial }{\partial [ Δ {σ}_{a} ( r ) ]} . & ( 40 )\end{matrix}$$

For example, equation (32) can be re-written as:

$$\frac{\partial P ( {r}^{′} )}{\partial [ Δ {S}_{w} ( r ) ]} = \frac{1}{a} {σ}_{w} {φ}^{m} ( r ) \frac{\partial P ( {r}^{′} )}{\partial [ Δ {σ}_{a} ( r ) ]} , \qquad ( 41 )$$

which enables one to invert time-lapse EM data for the change in water saturation.

### History-Matched Constraints

For the purpose of waterflood monitoring, the inversion may be subjected to the ancillary constraints that the total change in mass of water in the updated water saturation model is conserved:

m_{w}=∫_{V}ΔS_{w}(r)φ(r)ρ_{w}(r)d³r, (42)

where m_{w} is the total mass of water injected (known from production data), ρ_{w} is the water density (which may vary with salinity and temperature), and that the water saturation in the model can only increase:

ΔS_{w}(r)>0, (43)

and where the water saturation is bound:

0≦S_{w}(r)≦1−Sᵣ(r), (44)

where Sᵣ is the residual oil saturation.

### Other Considerations

In different embodiments, the method can be applied to the simultaneous modeling, inversion, and/or imaging of time-lapse EM data acquired during at least two different times. In some embodiments, workflows encapsulating the disclosed time-lapse EM analysis techniques can be inclusive of prior art modeling, inversion, and/or imaging methods of EM survey data collected at two or more different times. Such workflows can ensure data quality control, system calibration, and may eliminate cumulative errors since any systematic error in the time-lapse EM measurements will result in increasing absolute errors in the time-lapse EM data.

In different embodiments, the temporal and/or permanent emplacement of EM sources and/or EM field sensors is arbitrary, and such components may be placed on the surface, on the seafloor, or in at least one borehole. Further, the type of EM source used in the EM survey is arbitrary, and may include any electric and/or magnetic source types. Further, the type of EM field sensor used in the EM survey is arbitrary, and may include any electric and/or magnetic field sensor types such as but not limited to coils, electrodes, and fiber optic sensors.

The earth models mentioned herein can be constructed using industry-standard earth modeling software (e.g., DecisionSpace®) and workflows from available well, seismic, and production data. Further, rock and fluid attributes of the earth models can include porosity, permeability, oil saturation, gas saturation, and water saturation. The EM attributes of the earth models can include resistivity, conductivity, permittivity, permeability, chargeability, and other induced polarization (IP) parameters. Further, the EM attributes of the earth models can be either isotropic or anisotropic.

In some embodiments, the EM attributes of the earth model are populated from the interpolation and/or extrapolation of well-based resistivity data within well-tied seismic-based structural models. In these embodiments, the interpolation and/or extrapolation algorithms may be based on geostatistical methods. Also, the well-based resistivity data can be derived from any one or a combination of LWD resistivity or dielectric data, wireline resistivity or dielectric data, open-hole resistivity or dielectric data, cased-hole resistivity or dielectric data, through-casing resistivity or dielectric data, single-component resistivity or dielectric data, and multi-component resistivity or dielectric data.

In some embodiments, the EM attributes of the earth models can be related to the rock and fluid attribute of the earth models. Further, different attributes of the earth model may be assigned to different grids and/or meshes as required for different simulators. For example, the EM simulator will generally operate upon a different grid and/or mesh to a multi-phase flow simulator. In these embodiments, the attributes of one grid and/or mesh can be upscaled, down-scaled, interpolated and/or extrapolated to populate the attributes of another grid and/or mesh. Attribute transforms (e.g., calculating resistivity from porosity and water saturation) can be applied before or after such interpolations and/or extrapolations.

The workflows described herein can be implemented as either stand-alone software or integrated as part of a commercial earth modeling software (e.g., DecisionSpace) through an application programmable interface (API). Further, the dimensionality of the earth model and related EM simulator (e.g., 1D, 2D, 3D) is based on the interpreter's prejudice and/or requirement for solving particular reservoir monitoring problems. In some embodiments, an earth model of a lower dimensionality (e.g., 1D or 2D) can be extracted from an earth model of a higher dimensionality (e.g., 3D).

The EM simulator can be based on any combination of analytical, semi-analytical, finite-difference, finite-volume, finite-element, boundary-element, and/or integral equation methods. The simulation methods may be implemented in Cartesian, cylindrical and/or polar coordinates. Further, the EM simulator can be programmed on serial and/or parallel processing architectures. Likewise, EM modeling, inversion, and/or imaging algorithms may be implemented using software programmed for serial and/or parallel processing architectures. The processing of the EM modeling, inversion, imaging, and/or related functions may be performed remotely from the reservoir, where computers at the reservoir site are connected to the remote processing computers via a network (e.g., cloud computers). In such case, computers at the reservoir site should have high network reliability, but do not need high-computational performance, since EM modeling, inversion, and/or imaging can be performed by remote computers in real-time or near real-time.

In at least some embodiments, the disclosed time-lapse EM analysis can be used to perform joint inversion of time-lapse EM data with any other geophysical (e.g., seismic, time-lapse seismic, gravity, time-lapse gravity) and/or production (e.g., multi-phase flow) data. Further, the disclosed time-lapse EM analysis can be used for reservoir management systems, inclusive of intelligent completions and/or intelligent wells, for improved production enhancement.

In at least some embodiments, the disclosed time-lapse EM analysis can be used with a permanently installed fiber optic-based EM reservoir monitoring system. Further, the disclosed time-lapse EM analysis can be used with a permanently installed EM cement monitoring system for characterizing cement cure state and integrity. Further, the disclosed time-lapse EM analysis has relevance to drilling and wireline formation evaluation applications, and/or other EM-based monitoring applications.

The disclosed time-lapse EM analysis enables directly modeling, inverting and/or imaging upon time-lapse EM data to recover the time lapse changes in conductivity (resistivity), water saturation, hydrocarbon saturation, and carbon dioxide saturation attributes of earth models. Such time-lapse EM analysis is compatible with static, quasi-static, and dynamic earth models. Updates to such earth models may be performed in real-time.

In at least some embodiments, the disclosed time-lapse EM analysis can be applied to any surface, borehole, borehole-to-surface, cross-borehole, or marine EM method used for temporal and/or permanent reservoir monitoring. The disclosed time-lapse EM analysis can be used to monitoring different types of fluid such as oil, gas, water, carbon dioxide, water-based mud, oil-based mud, spacer, and/or cement. Further, the disclosed time-lapse EM analysis may be used with oil and gas production, carbon sequestration, enhanced oil recovery (EOR) operations (waterflooding and/or CO₂ injection), and/or groundwater operations.

For the disclosed time-lapse EM analysis, EM survey data may be acquired from at least two temporal surveys, where the position of EM source and/or EM field sensors has changed (e.g., cross-borehole EM, marine EM). In such case, interpolation, extrapolation, and/or integral transforms can be applied to redatum measured EM data from at least one temporal survey to the same EM source and/or EM field sensor positions of at least one other temporal survey such that time-lapse EM data between the at least two temporal EM surveys can be computed.

Embodiments disclosed herein include:

A: A time-lapse electromagnetic (EM) monitoring systems for a formation that comprises at least one EM source, and at least one EM field sensor to collect EM survey data corresponding to the formation in response to an emission from the at least one EM source, and a processing unit in communication with the at least one EM field sensor. The EM survey data includes first EM data collected at a first time and second EM data collected at a second time. The processing unit determines observed time-lapse EM data based on the first EM data and the second EM data. The processing unit performs an analysis of the observed time-lapse EM data to determine an attribute change in an earth model.

B: A time-lapse electromagnetic (EM) monitoring method for a formation that comprises emitting an EM field and collecting EM survey data corresponding to the formation in response to the emitted EM field. The EM survey data includes first EM data collected at a first time and second EM data collected at a second time. The method also comprising determining observed time-lapse EM data based on the first EM data and the second EM data, and analyzing the observed time-lapse EM data to determine an attribute change in an earth model.

Each of the embodiments, A and B may have one or more of the following additional elements in any combination: Element 1: the processing unit determines the observed time-lapse EM data using a perturbation tensor that defines a relationship between the first EM data and the second EM data. Element 2: the relationship is scalar. Element 3: the analysis corresponds to an inversion based on a comparison of the observed time-lapse EM data with simulated time-lapse EM data, wherein the inversion minimizes an error between the observed time-lapse EM data and the predicted time-lapse EM data subject to constraints imposed on an earth model. Element 4: further comprising at least one position sensor to determine position data corresponding to one or both of the first EM data and the second EM data, wherein the processor uses the position data to determine the observed time-lapse EM data. Element 5: the analysis relates the observed time-lapse EM data to a change in resistivity. Element 6: the determined attribute change is used to update a resistivity model or water saturation model. Element 7: the inversion subjects the attribute change to one or more rock physics constraints. Element 8: the inversion subjects the attribute change to history-matched constraints. Element 9: the inversion applies a sensitivity-based analysis to determine the attribute change. Element 10: further comprising a logging-while drilling (LWD) string or a wireline tool string to temporarily position the at least one EM source or the at least one EM field sensor in the formation. Element 11: further comprising a permanent well installation to permanently position the at least one EM source or the at least one EM field sensor in the formation.

Element 12: determining the observed time-lapse EM data comprises assigning a relationship between the first EM data and the second EM data. Element 13: further comprising changing the defined relationship as a function of delay between said first and second times. Element 14: said analyzing comprises comparing the observed time-lapse EM data with simulated time-lapse EM data and minimizing an error between the observed time-lapse EM data and the predicted time-lapse EM data subject to constraints imposed on an earth model. Element 15: further comprising determining position data corresponding to one or both of the first EM data and the second EM data, and using the position data to determine the observed time-lapse EM data. Element 16: said analyzing comprises relating the observed time-lapse EM data to a change in resistivity and subjecting the attribute change to one or more rock physics constraints. Element 17: said inverting comprises relating the observed time-lapse EM data to a change in resistivity and subjecting the attribute change to history-matched constraints. Element 18: said analyzing comprises relating the observed time-lapse EM data to a change in resistivity and applying a sensitivity-based analysis to determine the attribute change.

Numerous other variations and modifications will become apparent to those skilled in the art once the above disclosure is fully appreciated. It is intended that the following claims be interpreted to embrace all such variations and modifications where applicable.

1. A time-lapse electromagnetic (EM) monitoring system for a formation, comprising:
at least one EM source;
at least one EM field sensor to collect EM survey data corresponding to the formation in response to an emission from the at least one EM source, wherein the EM survey data includes first EM data collected at a first time and second EM data collected at a second time; and
a processing unit in communication with the at least one EM field sensor, wherein the processing unit determines a perturbation tensor that defines a relationship between the first EM data and the second EM data, wherein the processing unit determines observed time-lapse EM data based on the first EM data and the second EM data, and wherein the processing unit performs an analysis of the observed time-lapse EM data to determine an attribute change in an earth model.

2. (canceled)

3. The system of claim 1, wherein the relationship is scalar.

4. The system of claim 1, wherein the analysis corresponds to an inversion based on a comparison of the observed time-lapse EM data with predicted time-lapse EM data, wherein the inversion minimizes an error between the observed time-lapse EM data and the predicted time-lapse EM data subject to constraints imposed on an earth model.

5. The system of claim 1, further comprising at least one position sensor to determine position data corresponding to one or both of the first EM data and the second EM data, wherein the processor uses the position data to determine the observed time-lapse EM data.

6. The system of claim 1, wherein the analysis relates the observed time-lapse EM data to a change in resistivity.

7. The system of claim 1, wherein the determined attribute change is used to update a resistivity model or water saturation model.

8. The system of claim 1, wherein the analysis subjects the attribute change to one or more rock physics constraints.

9. The system of claim 1, wherein the analysis subjects the attribute change to history-matched constraints.

10. The system of claim 1, wherein the analysis applies a sensitivity-based analysis to determine the attribute change.

11. The system of claim 1, further comprising a logging-while drilling (LWD) string or a wireline tool string to temporarily position the at least one EM source or the at least one EM field sensor in the formation.

12. The system of claim 1, further comprising a permanent well installation to permanently position the at least one EM source or the at least one EM field sensor in the formation.

13. A time-lapse electromagnetic (EM) monitoring method for a formation, comprising:
emitting an EM field;
collecting EM survey data corresponding to the formation in response to the emitted EM field, wherein the EM survey data includes first EM data collected at a first time and second EM data collected at a second time;
determining observed time-lapse EM data based on the first EM data and the second EM data, wherein determining the observed time-lapse EM data comprises defining a relationship between the first EM data and the second EM data; and
analyzing the observed time-lapse EM data to determine an attribute change in an earth model.

14. (canceled)

15. The method of claim 13, further comprising changing the defined relationship as a function of delay between said first and second times.

16. The method of claim 13, wherein said analyzing comprises comparing the observed time-lapse EM data with predicted time-lapse EM data and minimizing an error between the observed time-lapse EM data and the predicted time-lapse EM data subject to constraints imposed on an earth model.

17. The method of claim 13, further comprising determining position data corresponding to one or both of the first EM data and the second EM data, and using the position data to determine the observed time-lapse EM data.

18. The method of claim 13, wherein said analyzing comprises relating the observed time-lapse EM data to a change in resistivity and subjecting the attribute change to one or more rock physics constraints.

19. The method of claim 13, wherein said analyzing comprises relating the observed time-lapse EM data to a change in resistivity and subjecting the attribute change to history-matched constraints.

20. The method of claim 13, wherein said inverting comprises relating the observed time-lapse EM data to a change in resistivity and applying a sensitivity-based analysis to determine the attribute change.
